(19) United States
(12) Patent Application Publication
(10) Pub. No.: US 2026/0313767 A1
(43) Pub. Date: Oct. 8, 2026

(54) RIPPLE CONTROL OF AN LED DRIVING CIRCUIT

(71) Applicant: SIGNIFY HOLDING B.V., EINDHOVEN (NL)

(72) Inventors: GANG WANG, SHANGHAI (CN); LIANG SHI, SHANGHAI (CN); JIE FU, SHANGHAI (CN)

(21) Appl. No.: 19/472,727

(22) PCT Filed: Apr. 2, 2024
(86) PCT No.: PCT/EP2024/058937

§ 371 Date: Oct. 6, 2025

(30) Foreign Application Priority Data
Apr. 7, 2023 (WO) PCT/CN2023/087003
May 25, 2023 (EP) 23175276.7

(51) Int. Cl. H05B 45/36; H05B 45/355; H05B 45/3725; H05B 45/59

(52) U.S. Cl. CPC H05B 45/36; H05B 45/355; H05B 45/3725; H05B 45/59

(57) ABSTRACT

A mechanism for selectively suppressing or allowing ripple into an output DC power for driving an LED lighting arrangement. Occupancy information is obtained and used to control the enabling and disabling of a smoothing circuit that attenuates ripple in the output DC power.

### FIELD OF THE INVENTION

The present invention relates to the field of LED lighting, and in particular to LED driving circuits.

### BACKGROUND OF THE INVENTION

The increasing use of artificial light is causing a greater demand for LED lighting devices. In particular, there is a demand for LED lighting devices that output light with minimal or imperceptible flicker for reducing an eye strain of an individual and/or consistent lighting of an environment.

A common cause of flicker in output light is the presence of a ripple in a DC power provided by an LED driving circuit to an LED lighting arrangement (of an LED lighting device). This ripple typically results from the production of the DC power by rectifying and converting an AC input voltage (e.g., a mains voltage). Such a ripple can be labelled a mains frequency ripple.

It is common for an LED driving circuit of an LED lighting device to comprise a smoothing circuit for attenuating or removing at least some of the ripple in the DC power, thereby attenuating flicker in any light output by the LED lighting arrangement. A common and cost-effective method to realize low ripple is to use an active ripple current filter (ARF) in the LED driving circuit. An alternative method is to use passive buffer components.

There is an ongoing desire to improve the flexibility of use of an LED lighting device.

### SUMMARY OF THE INVENTION

A basic idea of the application is providing a flexibility of disallowing/allowing the (mains frequency) ripple according to occupancy information. wherein, in the known technologies, the occupancy information is used for turning on/off or diming up/down the light without tuning the ripple. The invention is defined by the claims.

According to examples in accordance with an aspect of the invention, there is provided an LED driving circuit for driving an LED lighting arrangement.

The LED driving circuit comprises: a power supply configured to: receive, at an input interface, an AC input voltage, with a ripple at an AC frequency; convert said AC input voltage into an output DC power; and output, at an output interface, the output DC power; a smoothing circuit configured to smooth the output DC power and remove at least part of the ripple at the AC frequency from the output DC power, and a controller to selectively enable or disable the smoothing circuit, characterized wherein: the LED driving circuit further comprises a control interface configured to receive a control command carrying occupancy information indicating an occupation of a space by an object; and the controller is configured to selectively enable or disable the smoothing circuit responsive to the occupancy information.

The present disclosure provides a technique for controlling the ripple of a DC power provided to an LED lighting arrangement that makes use of occupancy information. Thus, the power ripple used by an LED lighting arrangement changes responsive to the occupancy information, meaning that a ripple or flicker in output light will inevitably change responsive to the occupancy information. This can provide various advantages and/or functions depending on where this technology is used. It facilitates, for instance, communication of occupancy information using an LED lighting arrangement via the presence or absence of flicker.

Thus, it is advantageously possible to (remotely) monitor or track occupancy information of a space by monitoring the light output by an LED lighting arrangement powered by the output DC power.

The proposed approach also facilitates improved control over power usage by or power leakage from the smoothing circuit, as selectively enabling or disabling the smoothing circuit will control an amount of power used by or leaked through the smoothing circuit.

The controller may be configured to selectively enable or disable the smoothing circuit responsive to the occupancy information so as to embed or encode the occupancy information into the output DC power whose ripple is to be detected by a remote detecting device for retrieving the occupancy information.

In this way, any light output by any LED lighting arrangement that is driven by the output DC power will carry an indicator of the occupation of a space by an object. This is because the presence of a ripple in the DC power will cause a flicker in the light output by such an LED lighting arrangement. Thus, output light will carry occupancy information that can be identified or retrieved by a remote detecting device (e.g., by monitoring for the presence/absence of flicker and/or a magnitude of a flicker).

The occupancy information may indicate whether or not a human individual is present in the space. The controller may be configured to enable the smoothing circuit when the human individual is present and disable the smoothing circuit when no human individual is present for more than a predetermined period of time.

When human is in the space, the LED driving circuit preferably activates the smoothing circuit and generates less flicker which may interfere with the human's visual perception (e.g., their sight or their eyes); otherwise the LED driving circuit is OK or permitted to disable the smoothing circuit.

The predetermined period of time may be non-zero. This provides a time-out/hysteresis mechanism for maintaining the ripple reduction. This can be advantageous to avoid repeated enabling and disabling of the smoothing circuit, e.g., if the individual is repeatedly entering and leaving the space. In examples, the predetermined period of time may a value between 5 minutes and 30 minutes inclusive.

In other examples, the predetermined period of time may be zero. This approach provides a mechanism by which the amount of ripple directly indicates the current or ongoing presence or absence of a human individual. This can be useful for tracking the location of the human individual, e.g., by monitoring for flicker in LED lighting arrangements driven by the LED driving circuit.

In some examples, the occupancy information indicates the likelihood that the human individual will remain in the space for more than a predetermined period of time.

The controller may be adapted to enable the smoothing circuit responsive to the likelihood indicating that the human individual is likely to remain in the space for more than the predetermined period of time; and disable the smoothing circuit responsive to the likelihood indicating that the human individual is not likely to remain in the space for more than the predetermined period of time.

In some examples, the likelihood relates to an installation location of the LED driving circuit in a whole layout and/or the location of the space in a whole layout. This is under the premise that the installation location of the LED lighting arrangement or the location of the space is strongly related to the likelihood of a human staying. For example, if the location is a corridor, the corresponding likelihood of a human staying is less than a likelihood corresponding to a location of working space. This LED driving circuit can have an interface to set or define the occupancy information upon installation, and is an alternative to that which uses a real occupancy sensor to detect the occupancy information in real time. The occupancy information is not necessarily human occupancy, but may indicate whether or not the space is occupied by an active visual capturing device. The controller may be configured to enable the smoothing circuit when the active visual capturing device is present and disable the smoothing circuit when no active visual capturing device is absent.

It has been herein recognized that an active visual capturing device (such as a camera) operates more effectively/without producing a Moire stripe on the captured data when in an environment illuminated with light having attenuated flicker, compared to unattenuated flicker. By enabling or activating the smoothing circuit when the visual capturing device is present and active, flicker of light output by any LED lighting arrangement driven by the output DC power is reduced.

In such examples, the occupancy information may, for example, be sent by the visual capturing device to the LED driving circuit via light-weighted communication protocol such as blue-tooth. Alternatively, the user may control the LED driving circuit via a backend cloud server.

In some examples, the controller is configured to prevent power loss in and/or extend the lifetime of the smoothing circuit when the controller disables the smoothing circuit. Thus, disabling the smoothing circuit, when the ripple is allowed/tolerated, may extend the lifetime of the smoothing circuit and/or prevent/reduce power loss in/through the smoothing circuit.

There are many implementations of the smoothing circuit, as well as many alternatives to enable/disable the smoothing circuit. Some example approaches are hereafter identified.

The smoothing circuit may comprise a power factor correction converter of the power supply and/or a secondary switched-mode power supply connected in series with the output interface of the power supply. The controller may be configured to bypass the smoothing circuit in order to disable the smoothing circuit.

The smoothing circuit may comprise a linear switch connected in series with the output interface of the power supply. The controller may be configured to make the linear switch enter a fully conductive mode in order to disable the smoothing circuit.

The smoothing circuit may comprises at least one capacitor-switch pair connected in parallel with the output interface of the power supply, each capacitor-switch pair comprising an output capacitor and a switch connected in series. The controller may be configured to open the switch so as to disconnect the output capacitor from the output interface of the power supply in order to disable the smoothing circuit.

There is also provided a lighting device comprising any herein disclosed LED driving circuit and an LED lighting arrangement configured to receive the output DC power produced by the LED driving circuit and emit light responsive to the received output DC power.

The LED lighting device may further comprise an occupancy sensor configured to: monitor the space and generate occupancy information responsive to the occupation of the space by the object; generate the control command using the occupancy information; and transmit the control command to the controller of the LED driving circuit.

There is also provided a remote detecting device for use with a herein disclosed LED driving circuit.

The remote detecting device comprises: a light detector configured to generate a detection signal responsive to light received, at the light detector, from a LED lighting arrangement driven by the LED driving circuit; a ripple detector configured to process the detection signal to determine the presence or absence of a ripple at the AC frequency; and an occupancy retrieval unit configured to retrieve the occupancy information using the determined presence or absence of the ripple at the AC frequency.

There is also provided a method of producing an output DC power for driving an LED lighting arrangement. The method comprises: receiving, at an input interface, an AC input voltage, with a ripple at an AC frequency; converting said AC input voltage into an output DC power; and outputting, at an output interface, the output DC power.

The method also comprises receiving a control command carrying occupancy information indicating an occupation of a space by an object; and selectively enabling and disabling a smoothing circuit responsive to the occupancy information, wherein, when enabled, the smoothing circuit is configured to smooth the output DC power and remove at least part of the ripple at the AC frequency from the output DC power.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a system in which embodiments can be employed;

FIG. 2 illustrates a proposed LED driving circuit;

FIG. 3 illustrates an alternative LED driving circuit;

FIG. 4 conceptually illustrates a driver for an LED driving circuit;

FIG. 5 conceptually illustrates another driver for an LED driving circuit;

FIG. 6 illustrates a smoothing circuit; and

FIG. 7 is a flowchart illustrating a proposed method.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for selectively suppressing or allowing ripple into an output DC power for driving an LED lighting arrangement. Occupancy information is obtained and used to control the enabling and disabling of a smoothing circuit that attenuates ripple in the output DC power.

One of the embodiments is based on the realization that controlling whether or not there is flicker in light output by an LED lighting arrangement can be used to communicate said occupancy information to a light sensitive device. Flicker in light output by an LED lighting arrangement is directly dependent upon an amount or magnitude of ripple in an output DC power that drives the LED lighting arrangement. Thus, it is herein proposed to selectively attenuate ripple dependent upon occupancy information, in order to facilitate communication of the occupancy information.

Proposed approaches can be employed in any suitable environment, including industrial, office and commercial environments, such as car parks.

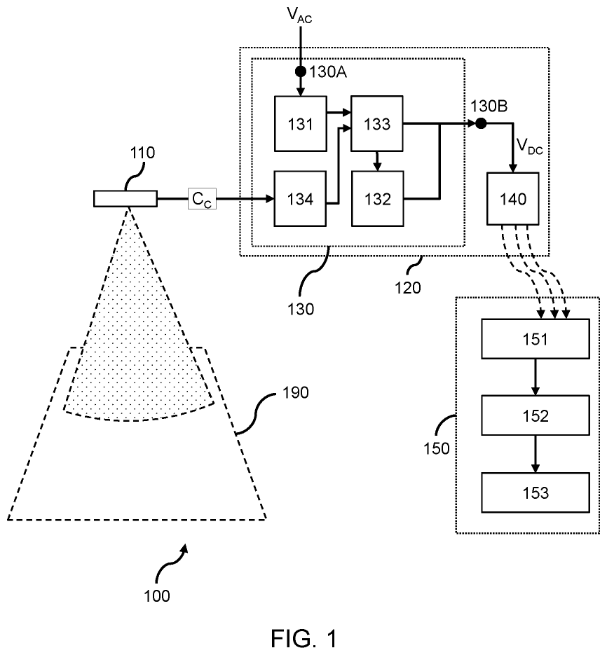

FIG. 1 illustrates a system 100 in which embodiments can be employed, for improved contextual understanding. The system comprises an occupancy sensor 110, an LED lighting device 120 and a remote detecting device 150.

The occupancy sensor 110 is configured to generate a control command C_{C} that carries occupancy information. The occupancy information indicates an occupation of a space 190 by an object. Thus, the occupancy sensor 110 is configured to monitor a space 190 to determine whether (or not) the space is occupied by an object.

Thus, the occupancy sensor 110 may be configured to monitor the space 190 and generate occupancy information responsive to the occupation of the space by the object. The occupancy sensor may then generate the control command using the occupancy information.

As a working example, the space 190 may be a car parking space and the detected object may be a car. As another example, the space 190 may be a working space (e.g., a desk) and the detected object may be a human. As yet another example, the space 190 may be a corridor and the detected object may be a moving object within the corridor. A wide variety of other possible spaces and objects are envisaged, such that the above list is non-exhaustive. Further embodiments will be hereafter described.

In preferred examples, the object is a human individual or human being. However, this is not essential and other examples will be apparent to the skilled person.

Examples of occupancy sensors 110 are well known in the art, and include infra-red (e.g., time-of-flight or PIR) sensors, radar sensors, LiDAR sensors, camera-based occupancy sensors, ultrasonic sensors and so on. One form of occupancy sensor is a motion sensor, which can use any previously mentioned technology to generate the occupancy data. Other forms of occupancy sensors can be used, e.g., sensors that monitor for an interaction with an electronic device located in the space (e.g., monitor for a user providing input to a computer or the like).

The LED lighting device 120 comprises an LED driving circuit 130 and an LED lighting arrangement 140. The LED driving circuit 130 is configured to convert an AC input voltage V_{AC} to provide an output DC power V_{DC} for driving the LED lighting arrangement 140.

The LED lighting arrangement receives any output DC power V_{DC} and powers one or more LEDs (e.g., an LED array, one or more strings of LEDs, an LED chip and so on) responsive to the received output DC power V_{DC}. Thus, the LED lighting arrangement 140 outputs light 195 using the received output DC power V_{DC}. At least some of the properties of the output light 195 are therefore 1dependent upon the properties of the received output DC power V_{DC}.

Preferably, the LED lighting arrangement 120 is configured and/or positioned so as to illuminate the space 190. Preferably, the LED lighting arrangement 120 is configured to produce light 195 of no less than 90 lumens, e.g., no less than 200 lumens, e.g., no less than 400 lumens.

The LED driving circuit 130 is configured to controllably (responsive to the control command C_{C}) change a level of attenuation of an AC frequency ripple, originally present in the AC input voltage, in the output DC power V_{DC}. The amount of AC frequency ripple in the output DC power V_{DC} will influence a flicker level in the light 195 output by the LED lighting arrangement 140. In particular, the less attenuated the ripple, the more flicker found in the light output by the LED lighting arrangement 140.

In this way, it is possible to facilitate communication of occupancy information by controlling the amount of flicker found in light 195 output by the LED lighting arrangement 140. The present disclosure thereby facilitates galvanically isolated and long-distance communication of occupancy information.

In order to control the level of attenuation of an AC frequency ripple found in the output DC power V_{DC}, the LED driving circuit comprises a power supply 131, a smoothing circuit 132, a controller 133 and a control interface 134.

The power supply 131 is configured to receive, at an input interface 130A, the AC input voltage V_{AC}. The AC input voltage V_{AC} may be provided, for instance, by a mains power supply (not shown). An AC input voltage will have a ripple or oscillation at the AC frequency, e.g., for a mains supply at 50 Hz or 60 Hz. The power supply 131 is configured to convert the AC input voltage V_{AC} to an output DC power V_{DC} and provide said output DC power at an output interface 130B.

The smoothing circuit 132 is configured to smooth the output DC power V_{DC} and remove at least part of the ripple at the AC frequency from the output DC power. Thus, the smoothing circuit acts as a ripple filter or ripple attenuation circuit. Examples of suitable smoothing circuits are well established in the art, but appropriate embodiments will be later described.

The controller 133 is configured to selectively enable or disable the smoothing circuit 132. In this way, the LED driving circuit is able to switch between a high ripple mode (when the smoothing circuit is disabled) and a ripple attenuation mode (when the smoothing circuit is enabled).

In the illustrated example, the controller 133 is configured to selectively bypass the smoothing circuit 132 so as to selectively enable or disable the smoothing circuit, but other suitable approaches will be apparent to the skilled person. A number of embodiments for this function will also be described later.

The control interface 134 is configured to receive the control command C_{C}. As previously explained, the control command C_{C} carries occupancy information indicating an occupation of a space 190. As a simple working example, the occupancy information may be binary data indicating whether or not it is predicted that the space contains the object. As a more complex example, the occupancy information may relate to a probability that the space contains the object. Here the occupancy information is not necessary the probability itself but is a condition corresponding to the probability, such a condition could relate to whether the LED driving circuit is installed in a location where human is likely to stay or not. And this condition could also be in a binary form.

It will therefore be clear that the occupancy sensor 110 is configured to transmit the control command to the controller 133 of the LED driving circuit via the control interface 134.

The controller 133 is configured to selectively enable or disable the smoothing circuit 132 (i.e., switch between the high ripple mode and the ripple attenuation mode) responsive to the occupancy information. Thus, the controller 133 is communicatively coupled to the control interface. The controller 133 may, for instance, enable the smoothing circuit 133 responsive to the occupancy information indicating that the space 190 is occupied by the object. Similarly, the controller 133 may disable the smoothing circuit 133 responsive to the occupancy information indicating that the space 190 is not occupied by the object.

In some examples, after enabling the smoothing circuit (e.g., when the object is present), the controller is configured to disable the smoothing circuit when the object is not present (i.e., no object is present) for more than a predetermined period of time. This provides a timing or time-out mechanism for disabling the smoothing circuit.

The predetermined period of time may be non-zero. This provides a time-out/hysteresis mechanism for maintaining the ripple reduction. This can be advantageous to avoid repeated enabling and disabling of the smoothing circuit 132, e.g., if the object is repeatedly entering and leaving the space. In examples, the predetermined period of time may a value between 5 minutes and 30 minutes inclusive.

In other examples, the predetermined period of time may be zero. This approach provides a mechanism by which the amount of ripple directly indicates the current or ongoing presence or absence of a human individual (or other object). This can be useful for tracking the location of the human individual (or other object), e.g., by monitoring for flicker in LED lighting arrangements driven by the LED driving circuit.

For the sake of illustrative clarity, the portions of the LED driving circuit have been illustrated as separate modules or components. However, it will be appreciated that different portions may in practice be combined into a single module or component. For instance, the smoothing circuit 133 may, in practice, form part of the power supply 131.

The remote detecting device 150 is configured to monitor an amount of flicker in the light 195 emitted by the LED lighting arrangement 140. By monitoring flicker, the LED lighting arrangement is able to derive or determine occupancy information about the space 190 without needing direct physical interaction with the occupancy sensor and/or the LED lighting device 120.

The remote detecting device 150 may comprise a light detector 151 configured to generate a detection signal responsive to light received, at the light detector, from the LED lighting arrangement 140. Examples of suitable light detectors 151 are well known in the art, and include photodiodes, photoresistors, camera arrays and so on.

The remote detecting device 150 may also comprise a ripple detector 152 configured to process the detection signal to determine the presence or absence of a ripple at the AC frequency. This can be readily achieved, for instance, by analyzing the detection signal in the digital domain using a Fourier-based transform (or similar) or by performing band-pass filtering of the detection signal at the AC frequency and averaging or integrating the band-passed signal (which can be performed in the analogue domain).

The remote detecting device 150 may comprise an occupancy retrieval unit 153 configured to retrieve the occupancy information using the determined presence or absence of the ripple at the AC frequency. In particular, the occupancy retrieval unit may process the determined presence or absence of the ripple to derive the occupancy information (e.g., as the presence/absence of a ripple will indicate the presence/absence or the absence/presence of an object in the space).

In a real example application of a car parking environment, the LED driving circuit broadcasts the occupancy information via the flicker/ripple of light, and an on-board camera in a vehicle is able to capture an image or video of the car parking lot and know which spot(s)/space(s) in the park lot have higher flicker/ripple light so as to know the occupancy information at each spot/space. This can allow, for instance, identification of an unoccupied spot or space, e.g., if an unoccupied spot is associated with light having a higher/flicker than an occupied spot/space. A similar working principle can take place when a user uses the camera on his/her smart phone to know the occupancy of working spaces, etc.

Of course, the remote detecting device 150 is not essential and can be omitted.

Besides the above embodiment of communicating the occupancy information via the ripple/flicker, proposed approaches of other embodiments also allow for control over the amount of flicker found in output light for other purposes, e.g., to reduce eye strain on an individual (in the space), to reduce strobing effects in an individual or camera in the space and so on in necessary conditions and not control the flicker otherwise.

In some examples, the occupancy sensor 110 forms part of the LED lighting device 120, e.g., is formed in a same housing or is otherwise structurally supported by the other components of the LED lighting device.

The proposed approach thereby introduces the concept of ripple-on-demand or flicker-on-demand, in which the flicker of the light output by the LED lighting arrangement is adjusted according to the occupancy status of the space. A motion/occupancy sensor is able to detect the occupancy/vacancy of the space which is illuminated by an LED lighting arrangement (i.e., a lighting fixture).

In one working example, when the space is vacant as detected by the occupancy sensor, the LED driving circuit enters into a ripple-allowing mode: it disables the ripple removal function (i.e., disables the smoothing circuit), such that the light flicker is increased. This can be simply realized by e.g., bypassing the smoothing circuit and directly outputting a high ripple current to the LED lighting arrangement. This is based on the insight that it not essential to provide low flicker light to a space where no person is present.

In this working example, when the space become occupant as detected by the occupancy sensor, the LED driving circuit goes back to normal operation mode with low ripple output, i.e., enables the smoothing circuit for a well-being of the human.

A number of working examples and scenarios for using such a system are hereafter described. These examples are non-exhaustive, but serve to demonstrate the flexibility of the proposed approach and demonstrate its advantages in specific implementations.

In a first scenario, the system is employed in an office environment. The occupancy sensor 110 is configured to monitor for desk occupancy (i.e., the space 190 is a desk and the object is an individual using the desk). For example, the occupancy sensor 110 may comprise an Advanced Sensor Bundle available from Signify® that uses a multi-pixel thermal pile sensor for monitoring whether a desk is occupied or empty.

In this first scenario, the LED driving circuit, for a LED lighting arrangement mounted on the ceiling area above a certain desk, can change its working mode (i.e., selectively enable or disable the smoothing circuit) responsive to occupancy information produced by the occupancy sensor 110. Once the desk becomes empty, the LED driving circuit enters a high ripple mode. Once it becomes occupied, the LED driving circuit goes back to a normal mode (i.e., ripple attenuation mode).

The first scenario demonstrates an example of a suitable place and object for the occupancy information. In particular, this approach will generate low flicker light when a human it at or using the desk, which is desirable for reducing eye strain and/or remotely indicating the presence of the human at the desk.

In a second scenario, the system may be employed to monitor for the presence of an active visual capturing device (e.g., a camera) in the space. Thus, the occupancy information may indicate whether or not there is an active visual capturing device. An active visual capturing device is one that is in the process of, or preparing to, capture an image or video. Approaches for identifying the presence of an active visual capturing device are known, e.g., by the active visual capturing device emitting a signal that is received by the occupancy information or by monitoring for a specific light or indicator that the active visual capturing device provides to indicate a photograph is being taken (e.g., a flash).

In this second scenario, the LED driving circuit, for an LED lighting arrangement in the vicinity of the space (e.g., illuminating at least part of the space) can change its working mode responsive to the occupancy information. In particular, the LED driving circuit may enter a high ripple mode- and disable the smoothing circuit-when no active visual capturing device is identified (i.e., the occupancy information indicates that there is no active visual capturing device). The LED driving circuit may enter a ripple attenuation mode—and enable the smoothing circuit—when an active visual capturing device is identified.

This second scenario appreciates that use of a camera would benefit from low flicker lighting, e.g., to avoid strobing or Moire effects due to the framerate of the camera.

This second scenario demonstrates an example of a suitable object for the occupancy information.

In a third scenario, the occupancy information indicates the likelihood that the human individual will remain in the space for more than a predetermined period of time. This can, for instance, be determined based on a movement of the object and/or the location of the space. For instance, if the object is moving and the location is a transition area (such as corridor or walkway), it can be determined that the human individual is not likely to remain in the space for more than predetermined period of time. Other suitable examples will be apparent to the skilled person.

In this third scenario, the controller is adapted to enable the smoothing circuit responsive to the likelihood indicating that the human individual is likely to remain in the space for more than the predetermined period of time; and disable the smoothing circuit responsive to the likelihood indicating that the human individual is not likely to remain in the space for more than the predetermined period of time. In this scenario, the LED driving circuit can make use with a manual switch, set by the installer according to the installation location, to configure the LED driving circuit work in the flicker suppressing mode (ripple attenuating mode) or allowing mode (high ripple mode). Alternatively, the LED driving circuit can equip with an electrical communication interface to receive the command in real time.

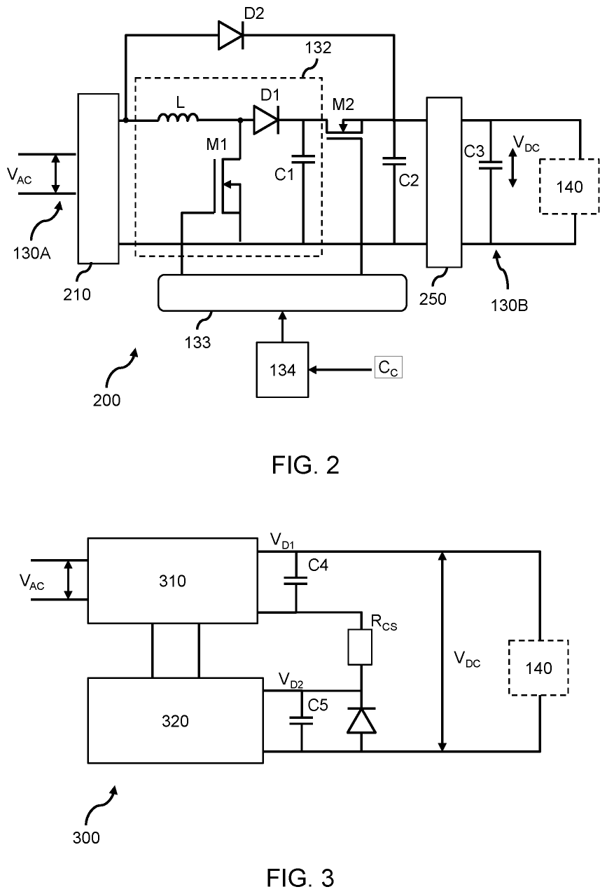

FIG. 2 illustrates an example LED driving circuit 200.

The LED driving circuit 200 comprises a power supply configured to receive, at an input interface 130A an input voltage V_{AC} and output, at an output interface 130B, an output DC power V_{DC}. The input voltage V_{AC} has a ripple at an AC frequency. The power supply is configured to convert the input voltage V_{AC} into the output DC power VDC.

The illustrated LED driving circuit 200 comprises a rectifier 210, that is configured to rectify the AC input voltage V_{AC} to produce a pulsating or oscillating rectified (DC) signal. Examples of rectifiers are well known in the art, and have described for the sake of conciseness. The rectifier may, for instance, be a bridge rectifier, half-wave rectifier, full-wave rectifier and so on.

The LED driving circuit 200 also comprises a smoothing circuit 132. The smoothing circuit is configured to (when enabled) smooth the output DC power and remove at least part of the AC frequency from the output DC power.

The smoothing circuit 132 here comprises a boost converter, comprising an appropriately arranged inductor L, diode D1, capacitor C1 and switch M1. The illustrated boost converter is arranged in a well-known configuration, but alternative arrangements will be known to the skilled person. When activated, the smoothing circuit 132 performs a boost conversion process that smooths a received (rectified) signal at its input.

To facilitate selective enabling and disabling of the smoothing circuit, a bypass diode D2 is connected in parallel with the smoothing circuit. Thus, an anode of the bypass diode D2 connects from the input of the smoothing circuit to bypass the smoothing circuit. A bypass switch M2 is connected between the output interface of the smoothing circuit and the cathode of the bypass diode D2. The cathode of the bypass diode D2 is also coupled to a plate of a second capacitor C2, the other plate of which is coupled to a return line of the boost converter.

To bypass the smoothing circuit, the bypass switch M2 can be made non-conductive. This effectively isolates the boost converter from the second capacitor C2. In this way, the voltage across the second capacitor is less smooth (i.e., the AC frequency ripple is less attenuated) when the bypass switch is made non-conductive.

It will be appreciated that the second capacitor C2 performs some smoothing for the output DC power V_{DC}, both when the smoothing circuit 132 is active and when the smoothing circuit 132 is disabled. The second capacitor C2 also performs a high frequency filtering function.

The switch M1 and/or the bypass switch M2 may be formed from a FET, such as a MOSFET, or any other form of switch.

The illustrated LED driving circuit 200 also comprises a buck converter 250 and a third capacitor C3. The buck converter receives the voltage across the second capacitor C2 and performs voltage conversion thereon. Thus, when the smoothing circuit 132 is active, the LED driving circuit 200 operates as a two-stage driver. When the smoothing circuit 132 is inactive or disabled, the LED driving circuit 200 operates as a single stage driver.

The boost converter (forming the smoothing circuit 132) and/or buck converter 250 may be replaced by any other form of power converter, e.g., a boost converter, a buck converter, a buck-boost converter, a flyback converter and so on. The configuration and operation of any such converter(s), including a buck converter, are well known in the art and are not described for the sake of conciseness.

The buck converter 250 and/or the third capacitor C3 may, in some embodiments, be omitted. However, their inclusion is preferred for achieving high power factor operation of the LED driving circuit, even when the smoothing circuit 132 is bypassed.

When the buck converter 250 is present, the second capacitor C2 also acts as an input film capacitor for the buck converter.

When the third capacitor C3 is present, the size of the second capacitor C2 can be reduced. This is because the third capacitor C3 can perform the smoothing and/or energy storage function for the output DC power V_{DC} in place of the second capacitor. The value of the second and/or third capacitor(s) may, for instance, depend upon an acceptable ripple for the output DC power when the smoothing circuit 132 is bypassed.

For the illustrated LED driving circuit 200, it will be appreciated that the power supply is formed across the entirety of the LED driving circuit. Thus, the smoothing circuit 132 is formed as part of the power supply itself.

The LED driving circuit 200 further comprises the controller 133 and the control interface 134. The controller 133 is here further configured to control the operation of at least the boost converter (or other form of smoothing circuit 132) when active (and, if present, the buck converter 250) according to known principles.

FIG. 3 schematically illustrates another LED driving circuit 300.

The LED driving circuit 300 has a two-driver topology. A first driver 310 performs AC/DC conversion of an AC input voltage V_{AC} and to perform power factor correction (PFC) on the AC input voltage V_{AC}. A second driver 320, when enabled, performs high-speed constant current control of the output DC power V_{DC}. The second driver 320 thereby acts as a secondary switched-mode power supply.

The sum of the outputs of the first driver 310 and the second driver 320 provide the output DC power V_{DC}. The first driver 310 outputs a first voltage V_{D1} and the second driver 320 outputs a second voltage V_{D2}. The sum of these two voltages is the output DC power V_{DC}. In particular, each driver provides its associated voltage across a respective output capacitor C₄, C₅, and the summed voltage across these output capacitors defines the output DC power V_{DC}.

When active, the second driver 320 is configured to sense a voltage across a sensing resistor Rcs connected in series with the output capacitors. This voltage V_{RS} (sensing voltage V_{RS}) represents a magnitude of the electrical current of the output DC power V_{DC}. By controlling the output DC power V_{DC} responsive to a difference between this voltage V_{RS} and a reference voltage, constant current control can be achieved.

The second driver thereby acts, when enabled, to perform smoothing of the output DC power VDC.

Two approaches for controlling the enabling and disabling of a smoothing circuit are hereafter described.

In a first approach, the second driver 320 is bypassed or disabled in order to disable the smoothing circuit. This will increase the ripple in the output DC voltage V_{DC}. The bypass/disabling circuitry is not illustrated, but approaches for disabling a circuit are well known (e.g., using one or more isolating switches).

In this first approach, the first driver 310 may be controlled to operate in a constant voltage mode when the second driver 320 is enabled and a constant current mode when the second driver is disabled.

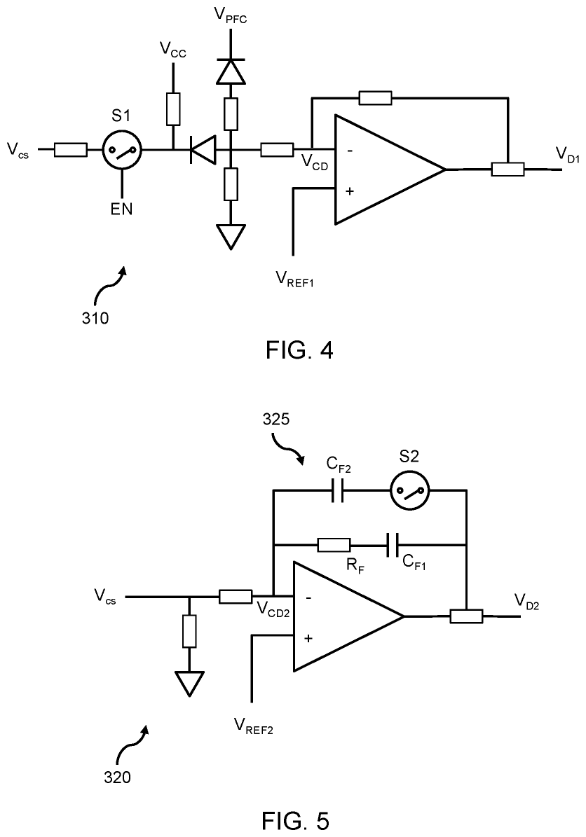

FIG. 4 schematically illustrates a portion of the first driver 310 that facilitates this approach.

The first driver 310 is configured to control a first driver output voltage V_{D1} responsive to a difference between a first reference voltage V_{REF1} and a driver control voltage V_{CD}. This is schematically illustrated with a feedback operational amplifier arrangement.

The output voltage V_{PFC} of the power factor correction arrangement is received as a possible feedback signal. The sensing voltage V_{RS} is also received as a possible feedback signal.

A switch S1 is configured to controllably connect and disconnect the sensing voltage V_{RS} from contributing to the driver control voltage V_{CD}. When the second driver is disabled, a switch S1 allows current to flow and allows the sensing voltage V_{RS} to contribute to the driver control voltage V_{CD}. When the second driver is enabled, the switch S1 prevents this current flow and prevents the sensing voltage V_{RS} from contributing to the driver control voltage V_{CD}.

In this way, the first driver is switched between using the sensing voltage V_{RS} as a feedback signal (when the second driver is disabled) and preventing use of the sensing voltage as a feedback signal (when the second driver is enabled). This allows for switching of the first driver between constant current control and constant voltage control respectively. This can allow for improved efficiency for high ripple applications.

In a second approach, to facilitate enabling and disabling of a smoothing circuit, the control parameters for the second driver 320 are modifiable.

FIG. 5 schematically illustrates a portion of the second driver 320 that facilitates this approach.

The second driver 320 is configured to control a second driver output voltage V_{D2} responsive to a difference between a second reference voltage V_{REF2} and a second driver control voltage V_{CD2}. This is schematically illustrated with a feedback operational amplifier arrangement.

The properties of the feedback circuitry 325 for the second driver 320 may be changed responsive to whether the smoothing circuit is to be enabled or disabled.

When the smoothing circuit is to be disabled, an additional feedback capacitor C_{F2} is connected (using switch S2) in parallel to the existing feedback capacitor C_{F1} and feedback resistor R_{F}. This decreases a response time of the second driver, making the second driver reduce the attenuation of any PFC output ripple, but achieving higher efficiency.

When the smoothing circuit is to be disabled, the additional feedback capacitor C_{F2} is disconnected (using switch S2) from the existing feedback capacitor C_{F1} and feedback resistor R_{F}. This increases a response time of the second driver, making the second driver perform better attenuation of any PFC output ripple, but at a lower efficiency.

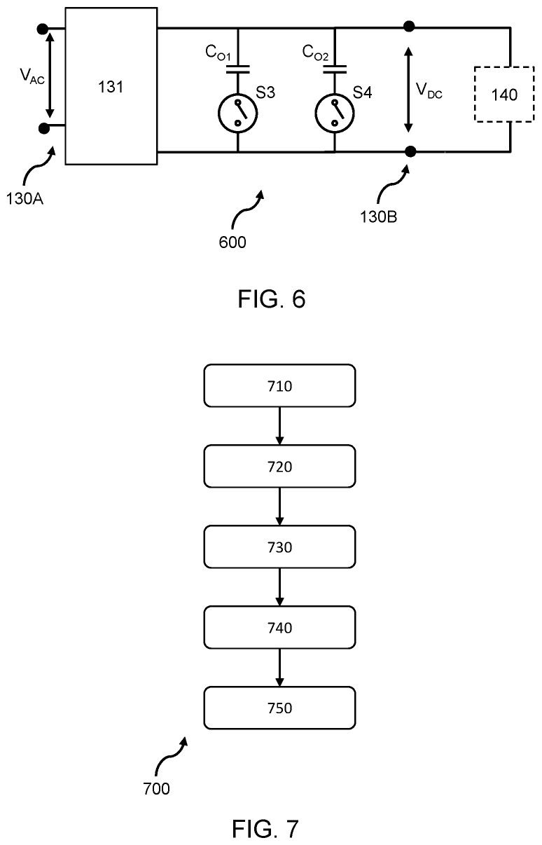

FIG. 6 illustrates another approach for enabling and disabling a smoothing circuit. In particular, FIG. 6 illustrates an alternative smoothing circuit 600.

The smoothing circuit 600 is connected to the output interface 130B of the power supply 131, and comprises at least one capacitor-switch pair C_{O1}, S3, C_{O2}, S4 connected in parallel with the output interface 130B of the power supply, each capacitor-switch pair comprising an output capacitor and a switch connected in series.

To switch between enabling and disabling the smoothing circuit, the number of capacitors connected in parallel to the output interface can be changed. For instance, to disable the smoothing circuit, the number of capacitors electrically connected in parallel can be reduced. To enable the smoothing circuit, the number of capacitors electrically connected in parallel can be increased.

Thus, the controller (not shown) may be configured to open the switch so as to disconnect the output capacitor from the output interface of the power supply in order to disable the smoothing circuit.

In the illustrated example, the smoothing circuit 600 comprises two capacitor-switch pairs. Each single capacitor-switch pair may be replaced by a set or group of two or more capacitor-switch pairs that operate in unison.

In one example, when the smoothing circuit is to be enabled, both capacitor-switch pairs are configured to simultaneously (e.g., continuously) connect their capacitors to the output interface to absorb the ripple current. In this example, when the smoothing circuit is to be disabled, both capacitor-switch pairs are configured to alternately connect their capacitors to the output interface, such that only one is connected at a time. This reduces the attenuation of the ripple current.

When each single capacitor-switch pair is replaced by a set or group of two or more capacitor-switch pairs, then each set may be alternately connected and disconnected from the output interface when the smoothing circuit is disabled.

This concept may be expanded to smoothing circuits with more than two capacitor-switch pairs (or more than two groups of capacitor-switch pairs). For instance, a smoothing circuit may comprise three or more groups of one or more capacitor-switch pairs, each capacitor-switch pair being connected in parallel with the output interface 130B. To enable the smoothing circuit, all capacitors (of all the capacitor-switch pairs) may be connected to the output interface. To disable the smoothing circuit, the capacitors of each group may be sequentially connected to the output interface on a group-by-group basis.

FIG. 7 is a flowchart illustrating a method 700 according to a proposed embodiment. The method 700 is for producing an output DC power for driving an LED lighting arrangement.

The method comprises a step 710 of receiving, at an input interface, an AC input voltage, with a ripple at an AC frequency; a step 720 of converting said AC input voltage into an output DC power; a step 730 of outputting, at an output interface, the output DC power; a step 740 of receiving a control command carrying occupancy information indicating an occupation of a space by an object; and a step 750 of selectively enabling and disabling a smoothing circuit responsive to the occupancy information, wherein, when enabled, the smoothing circuit is configured to smooth the output DC power and remove at least part of the ripple at the AC frequency from the output DC power.

The skilled person would be readily capable of modifying the method 700 to perform the function achieved by any herein disclosed LED driving circuit and/or LED lighting device.

Proposed approaches provide mechanisms for selectively suppressing or allowing flicker into light output by a LED lighting arrangement responsive to occupancy information. This approach can be combined with a technique that controls one or more other properties of light (e.g., intensity or color) to the occupancy information.

By way of example, the LED driving circuit may be configured to adjust a magnitude of the output DC power responsive to the occupancy information. As an example, the magnitude of the output DC power may be reduced and the smoothing circuit may be disabled responsive to the occupancy information indicating that no object (or no specific object such as a human) has been in the (monitored) space for a predetermined period of time (which may be zero or non-zero). As a further example, the magnitude of the output DC power may be increased and the smoothing circuit may be enabled responsive to the occupancy information indicating that an object (or a specific object such as a human) is in the space or was in the space no less than the predetermined period of time ago.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A LED driving circuit for driving an LED lighting arrangement, the LED driving circuit comprising:
a power supply configured to:
receive, at an input interface, an AC input voltage, with a ripple at an AC frequency;
convert said AC input voltage into an output DC power; and
output, at an output interface, the output DC power;
a smoothing circuit configured to smooth the output DC power and remove at least part of the ripple at the AC frequency from the output DC power, and
a controller to selectively enable or disable the smoothing circuit,
wherein:
the LED driving circuit further comprises a control interface configured to receive a control command carrying occupancy information indicating an occupation of a space by an object; and
the controller is configured to selectively enable or disable the smoothing circuit responsive to the occupancy information.

2. The LED driving circuit of claim 1, wherein the controller is configured to selectively enable or disable the smoothing circuit responsive to the occupancy information so as to embed or encode the occupancy information into the output DC power whose ripple is to be detected by a remote detecting device for retrieving the occupancy information.

3. The LED driving circuit of claim 1, wherein the occupancy information indicates whether or not a human individual is present in the space.

4. The LED driving circuit of claim 3, wherein the controller is configured to enable the smoothing circuit when the human individual is present and disable the smoothing circuit when no human individual is present for more than a predetermined period of time.

5. The LED driving circuit of claim 3, wherein:
the occupancy information indicates the likelihood that the human individual will remain in the space for more than a predetermined period of time; and
the controller is adapted to:
enable the smoothing circuit responsive to the likelihood indicating that the human individual is likely to remain in the space for more than the predetermined period of time; and
disable the smoothing circuit responsive to the likelihood indicating that the human individual is not likely to remain in the space for more than the predetermined period of time.

6. The LED driving circuit of claim 5, wherein the likelihood relates to an installation location of the LED driving circuit in a whole layout and/or the location of the space in a whole layout.

7. The LED driving circuit of claim 1, wherein the occupancy information indicates whether or not the space is occupied by an active visual capturing device, and the controller is configured to enable the smoothing circuit when the active visual capturing device is present and disable the smoothing circuit when no active visual capturing device is absent.

8. The LED driving circuit of claim 1-96 wherein the controller is configured to prevent power loss in and/or extend the lifetime of the smoothing circuit when the controller disables the smoothing circuit.

9. The LED driving circuit of claim wherein the smoothing circuit comprises a power factor correction converter of the power supply and/or a secondary switched-mode power supply connected in series with the output interface of the power supply, and the controller is configured to bypass the smoothing circuit in order to disable the smoothing circuit.

10. The LED driving circuit of wherein the smoothing circuit comprises a linear switch connected in series with the output interface of the power supply and the controller is configured to make the linear switch enter a fully conductive mode in order to disable the smoothing circuit.

11. The LED driving circuit of cla wherein the smoothing circuit comprises at least one capacitor-switch pair connected in parallel with the output interface of the power supply, each capacitor-switch pair comprising an output capacitor and a switch connected in series, and the controller is configured to open the switch so as to disconnect the output capacitor from the output interface of the power supply in order to disable the smoothing circuit.

12. An LED lighting device comprising:
the LED driving circuit of claim 1; and
an LED lighting arrangement configured to receive the output DC power produced by the LED driving circuit and emit light responsive to the received output DC power.

13. The LED lighting device of claim 12, further comprising an occupancy sensor configured to:
monitor the space and generate occupancy information responsive to the occupation of the space by the object;
generate the control command using the occupancy information; and
transmit the control command to the controller of the LED driving circuit.

14. A remote detecting device for use with the LED driving circuit of claim 2, wherein the remote detecting device comprises:
a light detector configured to generate a detection signal responsive to light received, at the light detector, from a LED lighting arrangement driven by the LED driving circuit;
a ripple detector configured to process the detection signal to determine the presence or absence of a ripple at the AC frequency; and
an occupancy retrieval unit configured to retrieve the occupancy information using the determined presence or absence of the ripple at the AC frequency.

15. A method of producing an output DC power for driving an LED lighting arrangement, the method comprising:
receiving, at an input interface, an AC input voltage, with a ripple at an AC frequency;
converting said AC input voltage into an output DC power;
outputting, at an output interface, the output DC power;
receiving a control command carrying occupancy information indicating an occupation of a space by an object; and
selectively enabling and disabling a smoothing circuit responsive to the occupancy information, wherein, when enabled, the smoothing circuit is configured to smooth the output DC power and remove at least part of the ripple at the AC frequency from the output DC power.
